(19) United States
(12) Patent Application Publication
(10) Pub. No.: US 2021/0049835 A1
(43) Pub. Date: Feb. 18, 2021

(54) SYSTEMS AND METHODS FOR ASSIGNING A VEHICLE IN RESPONSE TO A RIDESHARING REQUEST

(71) Applicant: c/o Toyota Motor North America, Inc., Plano, TX (US)

(72) Inventors: Scott R. Meyer, Allen, TX (US); Narendran Narayanasamy, Irvine, CA (US); Javier Castano, Richardson, TX (US)

(21) Appl. No.: 16/538,185

(22) Filed: Aug. 12, 2019

(51) Int. Cl. G07C 5/00; G01C 21/34; G01C 21/36

(52) U.S. Cl. CPC G07C 5/006; G01C 21/3438; G07C 5/008; G01C 21/3484; G01C 21/3469; G01C 21/3605

(57) ABSTRACT

A Mobility-as-a-Service system for assigning a vehicle in response to a ridesharing request includes one or more processors and a memory device in communication with the one or more processors. The memory device stores a receiver module and an assignment module. The receiver module includes instructions that cause the one or more processors to receive the ridesharing request that has an origin and a destination. The assignment module includes instructions that cause the one or more processors to assign the vehicle to respond to the ridesharing request based on the destination of the ridesharing request and a vehicle attribute of the vehicle related to the destination.

### TECHNICAL FIELD

The subject matter described herein relates, in general, to systems and methods for assigning a vehicle in response to a ridesharing request by a Mobility-as-a-Service (“MaaS”) system.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

MaaS systems that are operated by mobility service providers function by matching passengers with vehicles in response to ride requests from passengers. Generally, the ride request from the passenger includes an origin, sometimes referred to as a pickup location, and a destination. Some MaaS systems may calculate which vehicles are closest to the pickup location, using either time and/or distance, and assign the closest vehicle to the pickup location to respond to the ride request of the passenger.

### SUMMARY

This section generally summarizes the disclosure and is not a comprehensive explanation of its full scope or all its features.

In one embodiment, a MaaS system for assigning a vehicle in response to a ridesharing request includes one or more processors and a memory device in communication with the one or more processors. The memory device stores a receiver module and an assignment module. The receiver module includes instructions that cause the one or more processors to receive the ridesharing request that has an origin and a destination. The assignment module includes instructions that cause the one or more processors to assign the vehicle to respond to the ridesharing request based on the destination of the ridesharing request and a vehicle attribute of the vehicle related to the destination.

In another embodiment, a method for assigning a vehicle in response to a ridesharing request includes the steps of receiving the ridesharing request that includes an origin and a destination and assigning the vehicle to respond to the ridesharing request based on the destination of the ridesharing request and a vehicle attribute of the vehicle related to the destination.

In yet another embodiment, a non-transitory computer-readable medium for assigning a vehicle in response to a ridesharing request causes the one or more processors to receive the ridesharing request that includes an origin and a destination and assign the vehicle to respond to the ridesharing request based on the destination of the ridesharing request and a vehicle attribute of the vehicle related to the destination.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a general overview of a MaaS system for assigning a vehicle in response to a ridesharing request;

FIG. 2 illustrates a more detailed block diagram of a MaaS system for assigning the vehicle in response to the ridesharing request; and

FIGS. 3A-3D illustrate examples of methods for assigning a vehicle in response to a ridesharing request.

### DETAILED DESCRIPTION

A Mobility-as-a-Service (“MaaS”) system and related methods disclosed in the specification consider, at least in part, a destination of a ridesharing request and a vehicle attribute that is related to the destination. In one example, the vehicle attribute could be a need for vehicle maintenance. The vehicle needing maintenance may be assigned if the service shop performing the maintenance is near the destination indicated in the ridesharing request. The vehicle, after dropping off the passenger at the destination, could then travel to the service shop.

In another example, the vehicle attribute could be a vehicle with specialized capabilities, such as four-wheel-drive, snow tires, and the like. The assignment of the vehicle may be performed by determining if the destination in the ridesharing request requires a vehicle with specialized capabilities. If so, the vehicle with specialized capabilities will be assigned to respond to the ridesharing request.

In another example, the vehicle attribute could be the regular operating region of the vehicle. The assignment of the vehicle may be performed by determining if the destination is located within the regular operating region of the vehicle. This may be advantageous in some situations to partner the passenger with a driver that is familiar with points of interest around the destination, such as entertainment, restaurants, etc.

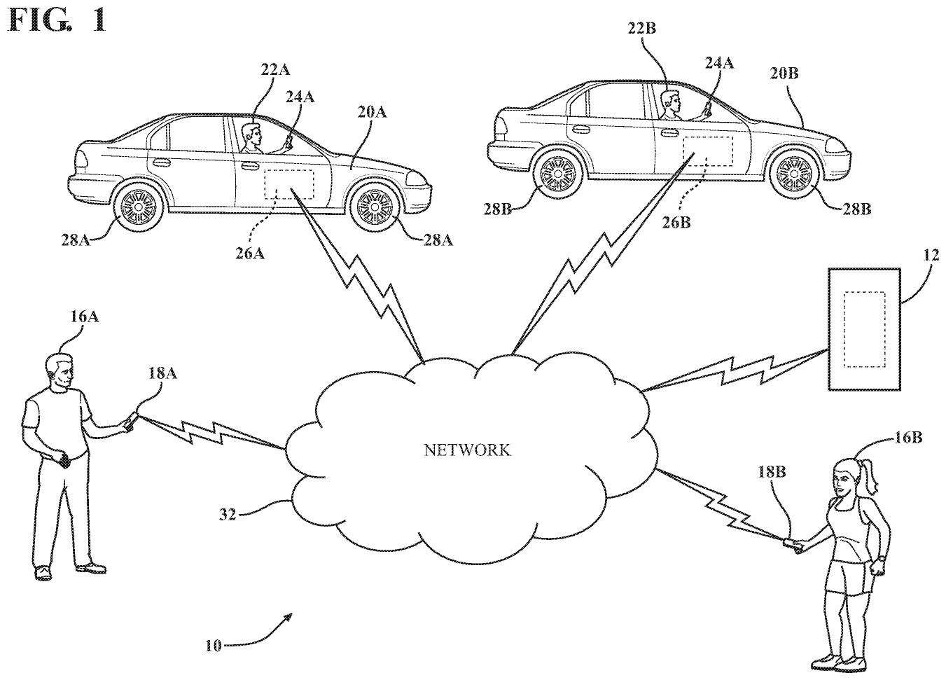

Referring to FIG. 1, a system 10 incorporating the MaaS system 12 is shown. The system 10 is essentially an example of one implementation of the MaaS system 12 for assigning a vehicle in response to a ridesharing request. In this example, the system 10 includes the MaaS system 12, passengers 16A and 16B and vehicles 20A and 20B. It should be understood that system 10 may have any number of vehicles, drivers, or passengers and is not limited to what is shown in the figures.

Here, the passengers 16A and 16B may have devices 18A and 18B, respectively. The devices 18A and 18B may be mobile devices that have the ability to communicate with the MaaS system 12 via a network 32, such as a distributed network. The network 32 may be the Internet. As such, the devices 18A and/or 18B may be mobile phones, tablet computers, notebook computers, and the like. It should be further understood that the devices 18A and/or 18B may not be mobile or handheld devices but could be fixed devices, such as a desktop personal computer, mainframe, and the like.

The vehicles 20A and 20B may be operated by drivers 22A and 22B, respectively. However, it should be understood that the vehicles 20A and/or 20B may be autonomous vehicles that do not require a driver to operate the vehicle. Further, it should be understood that the vehicles 20A and/or 20B may be any one of a number of different types of vehicles capable of transporting persons or items from one location to another.

In the example shown in FIG. 1, the vehicle 20A is in the form of an automobile having traditional tires 28A. The vehicle 20B is in the form of a sport utility vehicle that is equipped with four-wheel drive and snow tires 28B and/or chains 30 that allow the vehicle 20B to operate in adverse conditions, such as extremely snowy conditions. However, the vehicles 20A and/or 20B may take any one of a number of different forms with different capabilities, such as a truck, heavy-duty truck, tractor-trailer, tractor, mining vehicle, military vehicle, and the like. In addition, the vehicles 20A and/or 20B may not be limited to ground-based vehicles but could also include aircraft and seagoing vessels.

In the example where the vehicles 20A and/or 20B are autonomous vehicles and do not have a driver, the MaaS system 12 may communicate with a vehicle system 26A and 26B of the vehicles 20A and 20B, respectively. The vehicle system 26A and 26B of the vehicles 20A and 20B may have the ability to operate the vehicle to respond to ridesharing requests from the passengers 16A and/or 16B.

In the example where the vehicles 20A and/or 20B are non-autonomous or semi-autonomous vehicles, the MaaS system 12 may communicate to the driver 22A and 22B via a device 24A and 24B, respectively. The device 24A and/or 24B may be mobile devices that have the ability to communicate with the MaaS system 12 via the network 32. As such, the devices 24A and/or 24B may be mobile phones, tablet computers, notebook computers, and the like. Additionally or alternatively, the devices 24A and/or 24B may be incorporated within the vehicles 20A and 20B, respectively. For example, the devices 24A and/or 24B may be incorporated within a head unit of a vehicle that allows the drivers 22A and/or 22B to send and receive information with the MaaS system 12.

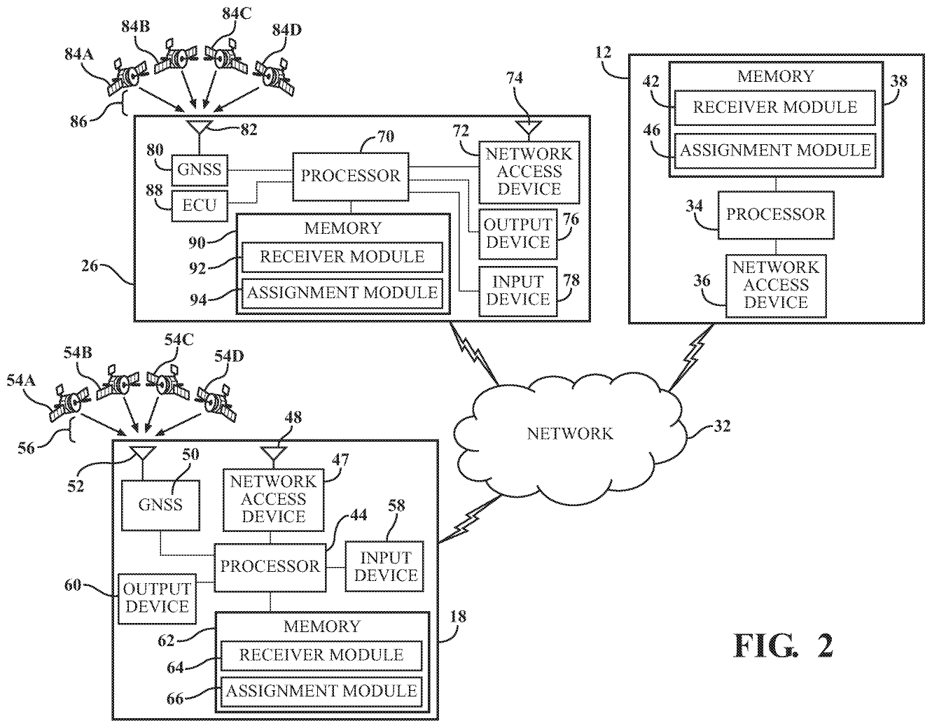

Referring to FIG. 2, a more detailed illustration of the MaaS system 12, device 18, and the vehicle system 26 are shown. The device 18 of FIG. 2 may be similar to the devices 18A and/or 18B of FIG. 1. Further, the device 18 may be similar to the devices 24A and/or 24B of FIG. 1. The vehicle system 26 may be similar to the vehicle systems 26A and/or 26B of FIG. 1.

The MaaS system 12 may include one or more processors 34, a network access device 36 in communication with the one or more processors 34 and a memory device 38 in communication with the one or more processors 34. The network access device 36 may be an electronic device, such as a circuit, that connects the one or more processors 34 to the network 32, such as the Internet. The network access device 36 may include any equipment required to make a connection to a wide area network from a local area network. As such, the network access device 36 acts as a conduit that allows for the communication of the one or more processors 34 to communicate with a number of different devices, such as the device 18 and/or the vehicle system 26.

The memory device 38 may be any type of memory capable of storing information that can be utilized by the one or more processors 34. As such, the memory device 38 may be a solid-state memory device, magnetic memory device, optical memory device, and the like. In this example, the memory device 38 is separate from the one or more processors 34, but it should be understood that the memory device 38 may be incorporated within any of the one or more processors 34, as opposed to being a separate device.

The memory device 38 may be capable of storing one or more modules that when executed by the one or more processors 34 cause the one or more processors 34 to perform any one of a number of different methods disclosed in this disclosure. In this example, the memory device 38 includes a receiver module 42 and an assignment module 46.

The receiver module 42 may include including instructions that when executed by the one or more processors 34 causes the one or more processors 34 to receive the ridesharing request. The ridesharing request including an origin and a destination and may have originated from the device 18. As previously described, the device 18 may be utilized by a passenger, such as passengers 16A and/or 16B of FIG. 1 to generate a ridesharing request.

The assignment module 46 may include instructions that when executed by the one or more processors 34 causes the one or more processors 34 to assign a vehicle, such as vehicle 20A or 20B of FIG. 1, to respond to the ridesharing request based on the destination of the ridesharing request and a vehicle attribute of the vehicle related to the destination. In one example, the vehicle attribute could include a maintenance need of the vehicle and a maintenance location. The vehicle needing maintenance may be assigned if the maintenance location is near the destination indicated in the ridesharing request. The vehicle, after dropping off the passenger at the destination, could then travel to the maintenance location.

The maintenance need of the vehicle could include anything related to the health of the vehicle. This could include fuel level of the vehicle, state of charge of the vehicle, last maintenance performed, miles since last maintenance performed, and an on-board-diagnostic trouble code. For example, if the vehicle has an internal combustion engine, the maintenance need could include when the last oil change was performed on the vehicle, and the distance traveled since the last oil change. If a determination is made that an oil change should be performed and the maintenance location for the oil change is near the destination in the ridesharing request, the vehicle may be assigned to respond to the ridesharing request and then, after dropping off the passenger at the destination, proceed to the maintenance location to have an oil change performed.

An onboard diagnostic trouble code could be provided to the MaaS system 12 to indicate to the MaaS system 12 that the vehicle may need service. The one or more processors 34 of the MaaS system 12 may be configured by the assignment module 46 to include this information when determining the maintenance need of the vehicle.

In another example, the vehicle attribute could be a vehicle with specialized capabilities or equipment, such as four-wheel-drive, snow tires, and the like. The assignment of the vehicle may be performed by determining if the destination and/or route to the destination in the ridesharing request requires a vehicle with specialized capabilities. These specialized capabilities could include having the vehicle equipped with snow tires and/or change to allow the vehicle to operate in adverse conditions. If so, the vehicle with specialized capabilities will be assigned to respond to the ridesharing request.

In another example, the vehicle attribute could be the regular operating region of the vehicle. The assignment of the vehicle may be performed by determining if the destination is located within the regular operating region of the vehicle. This may be advantageous in some situations to partner the passenger with a driver that is familiar with points of interest around the destination, such as entertainment, restaurants, etc. The regular operating region of the vehicle could include a region within a radius of the destination. This radius could be determined to be approximately 10 miles around the destination. Of course, it should be understood that any radius length could be utilized. Additionally or alternatively, operating regions may be broken down separately into predefined regions, such as city, county, township, and the like.

The regular operating region of the vehicle could include the percent of time, either operating or at a standstill, that the vehicle spends within the regular operating region. For example, a vehicle may be considered to be operating within a certain operating region when the vehicle spends more than 50% of the operating or standstill time within a certain operating region. The regular operating region could also include a region near the home address of the driver.

Additionally, it should be understood that the MaaS system 12 may be incorporated within the device 18 and/or the system 26. As such, the device 18 and/or the system 26 would also contain a processor and a memory device that includes the receiver module 42 and/or the assignment module 46. The device 18 and/or the system 26 would perform any of the operations performed by the MaaS system 12.

Further, the modules 42 and/or 46 could be a component of the one or more processors 34 or one or more of the modules 42 and/or 46 can be executed on and/or distributed among other processing systems to which the one or more processors 34 are operatively connected. For example, the device 18 and/or the system 26 could also execute and/or be included in the distribution among other processing systems to which the one or more processors 34 are operatively connected.

As to the device 18, the device 18 may be a mobile device, such as a mobile phone, that is operated by a passenger, such as devices 18A and/or 18B of FIG. 1. Additionally, the device 18 may be a mobile device, such as a mobile phone, that is operated by a driver, such as drivers 22A and/or 22B of FIG. 1.

The device 18 may include one or more processors 44 in communication with a network access device 47 a global navigation satellite system (“GNSS”) 50, an input device 58, an output device 60, and a memory device 62. The network access device 47 allows the one or more processors 44 of the device 18 to communicate with the network 32, such as the Internet. As such, the network access device 47 may be any one of a number of different components that allow the transmission of information to the network 32 and therefore to other electronic systems and subsystems connected to the network 32. These electronic systems and subsystems could include the MaaS system 12 and/or the vehicle system 26. The network access device 47 may be connected to an antenna 48 that allows for the wireless transmission and reception of data from the device 18.

The GNSS system 50 may be a satellite navigation system that provides autonomous geo-spatial positioning with global coverage. The GNSS system 50 may include any one of a number of different GNSS systems, such as GPS, GLONASS, Galileo, Beidou or other regional systems. The GNSS system 50 may be connected to an antenna 52 that is capable of receiving one or more signals 56 from one or more satellites 54A-54D. Based on the one or more signals 56 from one or more satellites 54A-54D, the GNSS system 50 is able to determine the relative location of the device 18 to which the GNSS system is installed. This relative location may be in the form of a coordinate system that may indicate the latitude, longitude, and/or altitude of the device 18 that has the GNSS system 50 installed within.

As such, the GNSS system 50 allows for one or more processors 44 to determine the relative location of the device 18, and then relay this information to the MaaS system 12 and/or the system 26 via the network access device 47. This may be useful in situations where the user of the device 18 is a passenger and the location of the device 18 from the GNSS system 50 can then be used in the ridesharing request from the passenger as the origin location.

The input device 58 may be any type of device that allows the driver or passenger to provide information to the one or more processors 44 of the device 18. As such, the input device 58 may be a touchscreen and/or keyboard that allows the passenger or driver to provide information to the one or more processors 44. The type of information that may be provided from the passenger or driver via the input device 58 may include, for example, the rideshare request from the passenger that includes the origin and the destination, information from a driver regarding the vehicle and vehicle attributes, information from the driver regarding the availability of the driver, etc.

The output device 60 may be any type of device that allows the passenger or driver to receive information from the one or more processors 44 of the device 18. The information from the one or more processors 44 could be information that originated from the MaaS system 12. In one example, the output device 60 may be a display device that visually displays information to the driver or passenger. Additionally, it should be understood that the input device 58 and the output device 60 may be incorporated as a touchscreen that allows for inputting information from the passenger or driver as well as displaying information to the passenger or driver. Information displayed by the output device 60 could include a request to pick up passenger from the MaaS system 12 (in the case when the device 18 is being used by a driver) or a user interface that allows the passenger to input an origin and/or destination that the passenger wishes to travel to (in the case when the device 18 is being used by a passenger).

The memory device 62 may include instructions for executing any one of a number of functions including the methods disclosed in this specification. For example, the modules 42 and/or 46 can be a component of the one or more processors 44, or one or more of the modules 42 and/or 46 can be executed on and/or distributed among other processing systems to which the one or more processors 44 are operatively connected.

With regards to the system 26, the system 26 may be incorporated within the automobile. The system 26 may include one or more processors 70 in communication with a network access device 72, a GNSS system 80, an input device 78, an output device 76, and a memory device 90. The network access device 72 allows the one or more processors 70 of the system 26 to communicate with the network 32. As such, the network access device 72 may be any one of a number of different components that allow the transmission of information to the network 32 and therefore to other electronic systems and subsystems connected to the network 32. These electronic systems and subsystems could include the MaaS system 12 and/or the device 18. The network access device 72 may be connected to an antenna 74 that allows for the wireless transmission and reception of data from the system 26.

Like the GNSS system 50 of the device 18, the GNSS system 80 may be a satellite navigation system that provides autonomous geo-spatial positioning with global coverage. The GNSS system 80 may be connected to an antenna 82 that is capable of receiving one or more signals 86 from one or more satellites 84A-88D. Based on the one or more signals 86 from one or more satellites 84A-88D, the GNSS system 50 is able to determine the relative location of the system 26 to which the GNSS system is installed. This relative location may be in the form of a coordinate system that may indicate the latitude, longitude, and/or altitude of the system 26.

As such, the GNSS system 80 allows for one or more processors 70 to determine the relative location of the system 26, and then relay this information to the MaaS system 12 and/or the device 18 via the network access device 72. This may be useful in determining the location of the system 26, and therefore any vehicle that the system 26 is installed in, and the regularly operating geographic region of any vehicle installed with the system 26.

The input device 78 and the output device 76 may be similar to the input device 58 in the output device 60 of the device 18. As such, the input device 78 and the output device 76 will not be described again, as the previously given descriptions of the input device 58 and the output device 60 are equally applicable here.

The memory device 90 may include instructions for executing any one of a number of functions including the methods disclosed in this specification. In one example, the memory device includes a receiver module 92 and an assignment module 94. The receiver module 92 and the assignment module 94 are similar to the receiver modules 42 and 64 and the assignment modules 46 and 66.

The memory device 90 may include instructions for executing any one of a number of functions including the methods disclosed in this specification. For example, the modules 42 and/or 46 can be a component of the one or more processors 70, or one or more of the modules 42 and/or 46 can be executed on and/or distributed among other processing systems to which the one or more processors 44 are operatively connected.

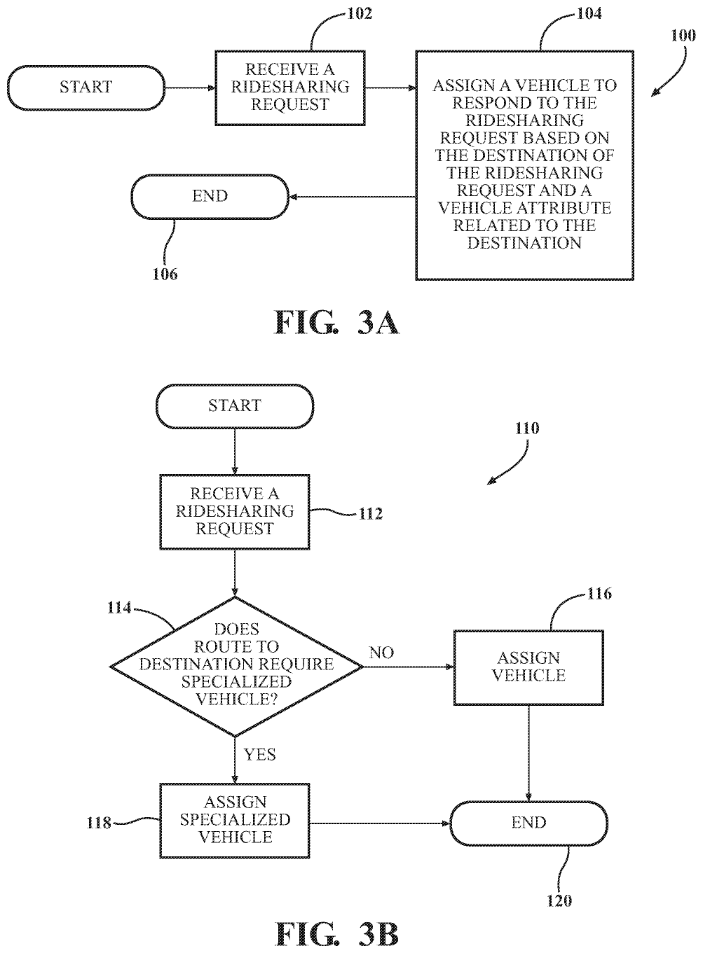

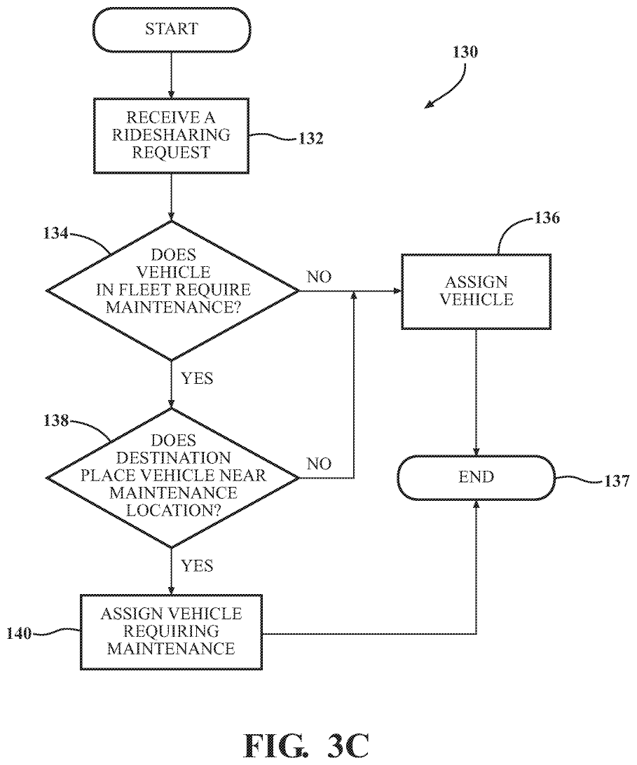

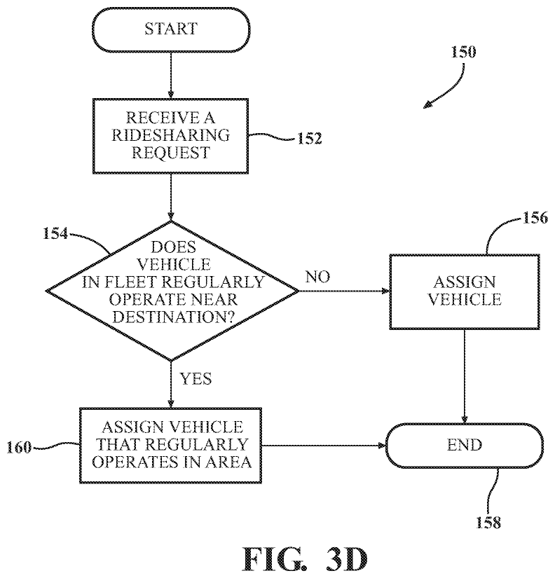

Referring to FIG. 3A, one example of a method 100 for assigning a vehicle in response to a ridesharing request will be discussed from the perspective of the MaaS system 12 of FIGS. 1-2. While method 100 is discussed in combination with the MaaS system 12, it should be appreciated that the method 100 is not limited to being implemented within the MaaS system 12 but is instead one example of a system that may implement the method 100.

At step 102, the receiver module 42 receives a ridesharing request. The ridesharing request may be initiated by a passenger using a device, such as the passenger 16A and the device 18A. The ridesharing request may include information regarding an origin and a destination for a trip. The ridesharing request could also include other information, such as requests for special accommodations, special vehicles, vehicles with specialized equipment, number of passengers, and the like. The ridesharing request may be received by a system, such as the MaaS system 12.

In step 104, the assignment module 46 assigns one of the vehicles 22A and/or 22B to respond to the ride-sharing request based on the destination of the ridesharing request and a vehicle attribute related to the destination. As stated previously, the vehicle attribute can include a different number attributes, such as the need for vehicle maintenance, information regarding the capabilities and/or equipment of the vehicle, and/or the regular operating region of the vehicle. After the vehicle has been assigned, the method 100 ends, as indicated in step 106.

Referring to FIG. 3B, another example of a method 110 for assigning a vehicle in response to a ridesharing request will be discussed from the perspective of the MaaS system 12 of FIGS. 1-2. While method 110 is discussed in combination with the MaaS system 12, it should be appreciated that the method 110 is not limited to being implemented within the MaaS system 12 but is instead one example of a system that may implement the method 110.

The method 110 begins at step 112, wherein a ridesharing request is received. The step 112 may be similar to the step 102 and will not be described again, as that description is equally applicable here.

In step 114, the assignment module 46 determines if the route to the destination requires a specialized vehicle and/or a vehicle equipped with specialized equipment. Examples of a destination and/or route to a destination that requires a specialized vehicle or equipment could include routes and destinations that include inclement weather and/or inclement conditions. As such, the specialized equipment could be snow tires or snow chains of a vehicle. The specialized vehicle could include a vehicle having a four-wheel-drive system. If it is determined that no specialized vehicle or vehicle with special equipment is necessary, the method will proceed to step 116 where the vehicle, which can be any vehicle available within the fleet, is assigned by the assignment module 46 to respond to the ridesharing request. Thereafter, the method ends as indicated in step 120. If a specialized vehicle or vehicle equipped with specialized equipment is necessary, the method 100 will proceed to step 118, wherein the Assignment module 46 assigns a specialized vehicle to respond to the route request. Thereafter, the method 100 ends as indicated in step 120.

Referring to FIG. 3C, another example of a method 130 for assigning a vehicle in response to a ride request will be discussed from the perspective of the MaaS system 12 of FIGS. 1-2. While method 130 is discussed in combination with the MaaS system 12, it should be appreciated that the method 130 is not limited to being implemented within the MaaS system 12 but is instead one example of a system that may implement the method 130.

Like before, the receiving module 42 receives a ridesharing request, as indicated in step 132. The step is similar to steps 102 and 112 and therefore will not be described again, as those descriptions are equally applicable here.

In step 134, the assignment module makes a decision if a vehicle in the fleet requires maintenance. If no vehicle in the fleet requires maintenance, the method proceeds to step 136 where a vehicle, which could be any vehicle within the fleet, is assigned by the assignment module 46 to respond in a ride request and the method ends as indicated in step 137.

If a vehicle within the fleet requires maintenance, the method 130 proceeds to step 138. In step 138, the assignment module 46 determines whether the destination indicated in the ride request places the vehicle needing maintenance near a maintenance location, which could be less than 10 miles. If not, the method proceeds to step 136 and a vehicle is assigned by the assignment module 46 to respond to the ride request. The vehicle assigned may not necessarily be the vehicle that is in need of maintenance.

If the assignment module in step 138 determines that the destination is near a maintenance location, the method 130 proceeds to step 140 wherein the vehicle needing maintenance is assigned by the assignment module 46 to respond to the ridesharing request. As such, the vehicle needing maintenance will respond to the ridesharing request, pick up the passenger at the origin, drop off the passenger at the destination, and then proceed to the maintenance location to have the necessary maintenance performed. By so doing, the assignment of the vehicle needing maintenance is performed more efficiently, as the vehicle will already be placed in a location near the maintenance location and will not need to make a separate specialized trip to have this maintenance performed. Thereafter, the method 130 ends, as indicated in step 137.

Referring to FIG. 3D, another example of a method 150 for assigning a vehicle to respond to a ridesharing request will be discussed from the perspective of the MaaS system 12 of FIGS. 1-2. While method 150 is discussed in combination with the MaaS system 12, it should be appreciated that the method 150 is not limited to being implemented within the MaaS system 12 but is instead one example of a system that may implement the method 150.

In step 152, a ridesharing request is received by the receiver module 42. The step 152 is similar to the steps 102, 112, and/or 112 of the previously described figures. As such, this step will not be described again, as those descriptions are equally applicable here.

In step 154, a determination is made by the assignment module 46 of whether a vehicle and the fleet regularly operates near the destination. The regular operation of the vehicle near the destination could be the percent of time that the vehicle spends in an area, such as a 10-mile radius around the destination or some predefined area. In one example, if the vehicle spends more than 50% of its operating and/or standstill time in a geographic area that is either near and/or includes the destination, it may be determined that the vehicle readily operates in that geographic region.

If a vehicle is found in the fleet that readily operates near the destination, the method proceeds to step 160, wherein that vehicle that regularly operates in the area is assigned by the assignment module 46 to respond to the ridesharing request. This may be advantageous in some situations to provide the passenger with a vehicle that is being operated by a driver that is familiar with the area in and around the destination that the passenger wishes to go. This allows the passenger the opportunity to converse with the driver to receive information regarding local interests, events, restaurants, entertainment venues, and the like. Thereafter, the method 150 ends as indicated in step 158. If no vehicle is found in the fleet that readily operates near the destination, the method proceeds to step 156 and may assign any vehicle from the fleet to respond to the ridesharing request.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer readable program code embodied, e.g., stored, thereon. Any combination of one or more computer-readable media may be utilized. The computer-readable medium may be a computer readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, may include one or more CMOS gates, combinations of gates, or other circuit components. Where multiple modules are described, one or more embodiments may include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for assigning a vehicle in response to a ridesharing request, the method comprising the steps of:
receiving the ridesharing request, the ridesharing request including an origin and a destination; and
assigning the vehicle to respond to the ridesharing request based on the destination of the ridesharing request and a vehicle attribute of the vehicle related to the destination.

2. The method of claim 1, wherein the vehicle attribute includes a maintenance need of the vehicle and a maintenance location, wherein the maintenance location performs the maintenance need of the vehicle.

3. The method of claim 2, wherein the maintenance need of the vehicle includes at least one of the following: fuel level, state of charge, last maintenance performed, miles since last maintenance performed, and an on-board-diagnostic trouble code.

4. The method of claim 2, further comprising the step of receiving, from an electronic control unit of the vehicle, information related to the maintenance need of the vehicle.

5. The method of claim 1, wherein the vehicle attribute includes a type of vehicle and a requirement of the type of vehicle to reach the destination.

6. The method of claim 5, wherein the type of vehicle includes a vehicle equipped with at least one of: snow chains and snow tires.

7. The method of claim 1, wherein the vehicle attribute includes a regular operating region of the vehicle, indicating a geographic region where the vehicle regularly operates within, wherein the regular operating region includes the destination.

8. A Mobility-as-a-Service (“MaaS”) system for assigning a vehicle in response to a ridesharing request, the MaaS system comprising:
one or more processors;
a memory device in communication with the one or more processors, the memory device storing:
a receiver module including instructions that when executed by the one or more processors causes the one or more processors to receive the ridesharing request, the ridesharing request including an origin and a destination; and
an assignment module including instructions that when executed by the one or more processors causes the one or more processors to assign the vehicle to respond to the ridesharing request based on the destination of the ridesharing request and a vehicle attribute of the vehicle related to the destination.

9. The MaaS system of claim 8, wherein the vehicle attribute includes a maintenance need of the vehicle and a maintenance location, wherein the maintenance location performs the maintenance need of the vehicle.

10. The MaaS system of claim 9, wherein the maintenance need of the vehicle includes at least one of the following: fuel level, state of charge, last maintenance performed, miles since last maintenance performed, and an on-board-diagnostic trouble code.

11. The MaaS system of claim 9, wherein the receiver module includes instructions to receiving, from an electronic control unit of the vehicle, information related to the maintenance need of the vehicle.

12. The MaaS system of claim 8, wherein the vehicle attribute includes a type of vehicle and a requirement of the type of vehicle to reach the destination.

13. The MaaS system of claim 12, wherein the type of vehicle includes a vehicle equipped with at least one of: snow chains and snow tires.

14. The MaaS system of claim 8, wherein the vehicle attribute includes a regular operating region of the vehicle, indicating a geographic region where the vehicle regularly operates within, wherein the regular operating region includes the destination.

15. A non-transitory computer-readable medium for assigning a vehicle in response to a ridesharing request cause the one or more processors to:
receive the ridesharing request, the ridesharing request including an origin and a destination; and
assign the vehicle to respond to the ridesharing request based on the destination of the ridesharing request and a vehicle attribute of the vehicle related to the destination.

16. The non-transitory computer-readable medium of claim 15, wherein the vehicle attribute includes a maintenance need of the vehicle and a maintenance location, wherein the maintenance location performs the maintenance need of the vehicle.

17. The non-transitory computer-readable medium of claim 16, wherein the maintenance need of the vehicle includes at least one of the following: fuel level, state of charge, last maintenance performed, miles since last maintenance performed, and an on-board-diagnostic trouble code.

18. The non-transitory computer-readable medium of claim 16, further comprising instructions that when executed by one or more processors cause the one or more processors to receive, from an electronic control unit of the vehicle, information related to the maintenance need of the vehicle.

19. The non-transitory computer-readable medium of claim 1, wherein the vehicle attribute includes a type of vehicle and a requirement of the type of vehicle to reach the destination.

20. The non-transitory computer-readable medium of claim 1, wherein the vehicle attribute includes a regular operating region of the vehicle, indicating a geographic region where the vehicle regularly operates within, wherein the regular operating region includes the destination.
